(19) United States
(12) Patent Application Publication
(10) Pub. No.: US 2013/0196146 A1
(43) Pub. Date: Aug. 1, 2013

(54) CLEAR PROTECTIVE COVERING FOR PERMANENT INSTALLATION ON COUNTERTOPS

(71) Applicant: Prestige Film Technologies, San Jose, CA (US)

(72) Inventors: Sammy Yu, Dublin, CA (US); Wilson Yu, Dublin, CA (US)

(73) Assignee: Prestige Film Technologies, San Jose, CA (US)

(21) Appl. No.: 13/754,836

(22) Filed: Jan. 30, 2013

Related U.S. Application Data
(60) Provisional application No. 61/593,206, filed on Jan. 31, 2012.

(51) Int. Cl. B32B 7/12

(52) U.S. Cl. CPC B32B 7/12
USPC 428/332; 428/354; 428/483; 428/457; 428/446; 428/426; 156/60

(57) ABSTRACT

A protective covering material for protecting solid surface countertop materials is provided. The protective covering material includes a core layer formed from a polymer material such as polyethylene which is formed as an elongate thin sheet of material having uniform thickness. The protective covering material also includes an outer protective clear coat layer attached to a first side of the core layer and an adhesive layer attached to a second side of the core layer. The protective covering material may be permanently attached to a countertop material with the adhesive layer to protect the countertop material from damage during daily use.

### RELATED APPLICATIONS

This application claims priority to U.S. Application No. 61/593,206, filed on Jan. 31, 2012.

### BACKGROUND INFORMATION

1. Field of the Disclosure

The present invention relates to the protection of countertops. In particular, examples of the present invention relate to a protective covering for application to solid surface stone countertops to protect the countertop from damage during daily use.

2. Background

Many consumers have adopted solid surface countertops such as stone, glass, recycled glass, composite stone or glass, etc. These materials have become increasingly common in applications such as residential kitchens and countertops, tables, commercial tables and counters. These materials provide an increased level of beauty to the consumer and typically provide a relatively durable surface. These surfaces, however, are not without their upkeep. Even with proper care, these countertop materials often begin to show wear, damage, stains and the like.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a side view illustrating a protective covering material according to the present invention.

FIG. 2 is another side view illustrating a protective covering material according to the present invention.

FIG. 3 is another side view illustrating a protective covering material according to the present invention.

FIG. 4 is a perspective view illustrating the protective covering material attached to a countertop.

FIG. 5 is a detailed side view of a portion of a countertop having the protective covering material attached thereto.

FIG. 6 is another detailed side view of a portion of a countertop having the protective covering material attached thereto.

FIG. 7 is a perspective view of a shower having the protective covering material applied to the shower surround.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

The disclosure particularly describes a protective covering for solid surface countertop materials and how such a covering may be installed and used to protect a solid surface countertop material. A covering may be a clear covering material which is applied to a countertop with an adhesive. The covering may include multiple layers to provide beauty, durability, protection, and convenient installation. The protective covering protects countertops from daily abuse and does not detract from the overall appeal of the countertop. The protective covering is particularly suited for use with solid surface countertops such as stone and glass countertops.

As discussed herein, solid surface countertops include natural and manmade materials. Natural solid surface countertop materials such as stones include, but are not limited to marble, granite, limestone, quartz, etc. Man-made countertop materials include manmade stones such as Caesarstone, glass countertops including recycled glass or tempered glass, and composite materials such as glass, quartz or other stone pieces in a mortar, grout, or cement binder, decorative elements including glass, stone, metals, etc. in a binder, acrylic and polyester blends, metals such as stainless steel or copper, and the like. These decorative and other similar countertop materials are frequently referred to collectively as solid surface countertop materials, solid surface countertops, or countertops in the present application.

These solid surface countertops may be used in various different applications. These countertop materials are often used in residential counters, backsplashes, bars, showers, vanities, work surfaces, tables, furniture, etc. These countertop materials are also used in similar commercial applications such as countertops, tables, and the like in restaurants, store displays, etc. These applications are frequently referred to collectively as ‘countertops’ in the present application.

Daily use of these solid surface countertop materials frequently includes contact with tools such as kitchen utensils, bowls, cups, plates, purses or bags, electronic devices, etc. which will mechanically damage the countertop material. These countertop materials are also frequently exposed to contaminants such as dirt, foods, cooking oils, and the like which will stain the countertop material. Many of these contaminants chemically damage the countertop material. This chemical damage includes hard water etching, and chemical etching (often from orange juices, lime juices, coffee, tomato juice, wine, and other acidic liquids). Chemical etching can wear down the countertop material, rendering it aesthetically unpleasant as well as damaging the countertop surface and in some cases, weakening the countertop material structurally. This chemical damage can promote mechanical damage such as chipping and cracking.

Additional environmental damage to these countertop materials may include fading, chemical damage, and degradation of the countertop material from exposure to ultraviolet light. In some cases, this damage may require restorative measures such as grinding, polishing, and resin filling that can be costly. In some instances, replacement of the countertop material may be necessary as the material may become hazy, weakened, or discolored from improper care and the damage associated with environmental exposure and daily use.

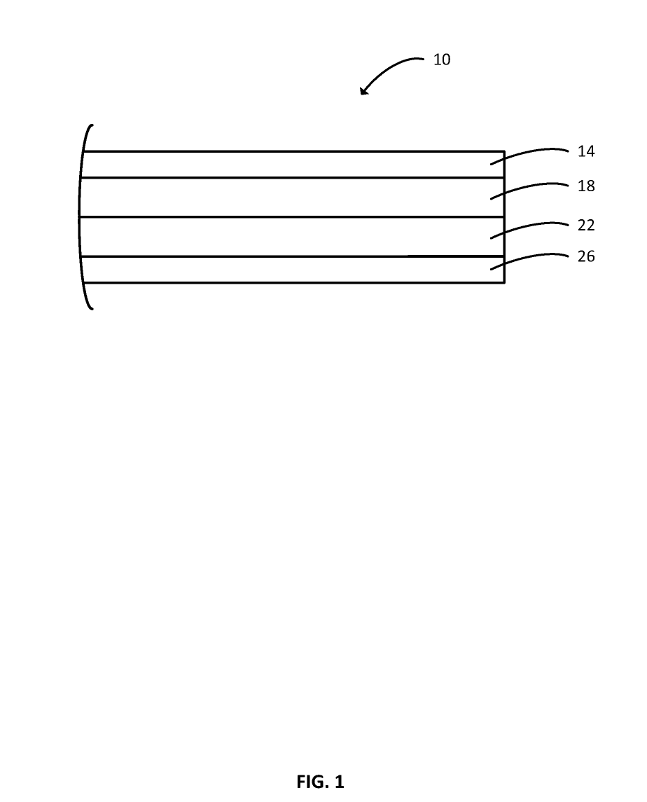

Referring to FIG. 1, a protective covering material 10 for solid surface countertops may include multiple layers. The protective covering material 10 may include a first layer 14 that is a durable clear coat. The first layer 14 may be referred to as an outer layer or a wear layer. The first layer 14 may be a scratch and chemical resistant clear coat which includes a UV inhibiting compound. This UV inhibiting first layer 14 blocks out 95% of ultraviolet rays between 190 nm and 380 nm of the solar spectrum, providing effective UV protection to a countertop material which is protected by the covering material 10.

In one example, the outer layer may include a temperature and scratch resistance polymer coating such as an acrylic polymer. More particularly, the outer layer 14 may be formed from aliphatic urethane acrylate and dipentaerythritol hexacrylate, and may additionally be formed from hydroxycyclohexyl phenyl ketone and methyl isobutyl ketone, butyl acetate, propylene glycol monomethyl ether, and n-butanol. The outer layer 14 may further include an antibacterial agent and silicon dioxide to enhance the durability thereof. An example outer layer 14 may be formed from a polymerized and cured mixture of aliphatic urethane acrylate, dipentaerythritol hexacrylate, hydroxycyclohexyl phenyl ketone, methyl isobutyl ketone, butyl acetate, propylene glycol monomethyl ether, n-butanol, an antibacterial agent, and silicon dioxide. The outer layer 14 may be about 0.0015 or 0.002 inches thick.

The anti-bacterial agent may be an organic antibacterial agent or may be a metal nanoparticle antibacterial agent. Organic antibacterial agents may include triclosan, ammonia, chloride bearing compounds, or polyol ester. Metal nanoparticle antibacterial agents may include nickel, cerium, gold, palladium, platinum, silver, zinc, copper, aluminum, or tungsten metals and compounds thereof such as oxides thereof. Typical nanoparticles of a metallic antibacterial agent may be sizes between about 1 nm and 1000 nm and may be formed in a coating which is between about 0.001 and about 0.0025 inches thick. The antibacterial agent may be mixed throughout the outer layer 14. In some cases, such as those involving the use of metal nanoparticles, the antibacterial agent may be formed as a layer, such as a layer on the outside surface of the outer layer 14 and which may often be between 0.001 and 0.0025 inches thick.

The protective covering material 10 may include a second layer 18 which forms the core substrate of the covering material 10. As such, the second layer 18 may be referred to as an inner layer, center layer, or as a core layer. The second layer 18 may be made of a polymer such as a polyolefin. Examples of the protective covering material are made with a polyethylene core layer 18. In one example, the core layer may be formed from a super optical grade primer treated polyethylene terephthalate.

The second layer may provide mechanical strength to the protective covering material. As such, the second layer 18 may provide sufficient strength to support the first layer 14 and may provide sufficient mechanical strength to apply the protective covering material 10 to a solid surface countertop and otherwise work with the covering material 10.

The protective covering material 10 may include a third layer 22 which is an adhesive layer. The third layer 22 may be formed of an acrylic pressure sensitive adhesive or a silicone adhesive layer. The third layer 22 may be selected such that the adhesive adheres to all of the countertop materials discussed herein including stones, solid surface countertops (including man-made and natural materials), glass, recycled glass, etc. In many situations, the protective covering material 10 may be applied to a countertop using a liquid and squeegee to apply the covering material 10, remove bubbles and wrinkles from underneath the material and properly attach the protective covering material 10 to a countertop.

The adhesive layer 22 may be formed from an acrylic adhesive which may serve as a general purpose adhesive. The acrylic adhesive is suitable for use with many natural or synthetic stone and stone like countertop materials and provides a durable bond attaching the protective covering material 10 to the countertop material. The adhesive layer 22 may be formed from a silicone adhesive which may be better suited for countertop materials such as stainless steel. The adhesive layer may be approximately 0.02 inches thick.

The protective covering material 10 may include a fourth layer 26 which protects the adhesive material in the third layer 22. The fourth layer 26 may be a release paper, release liner, or a release film which is compatible with the adhesive used in the third layer 22 and may thus be referred to as a release layer, release paper, or release film. In one example, the release liner may be a silicon treated polyethylene terephthalate. The fourth layer 26 protects the adhesive third layer 22 from contamination until the protective covering material 10 is installed on a countertop. The release liner may often be about 0.025 inches thick.

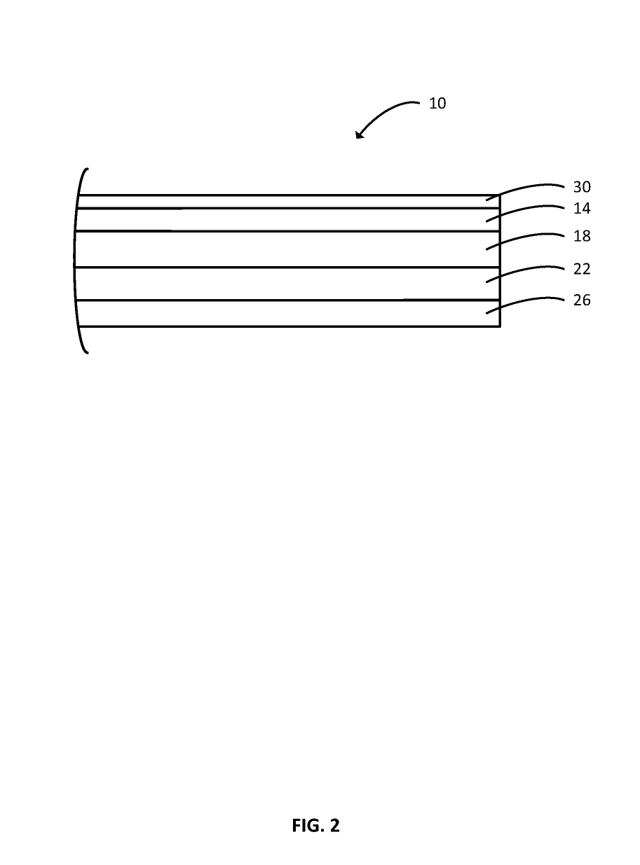

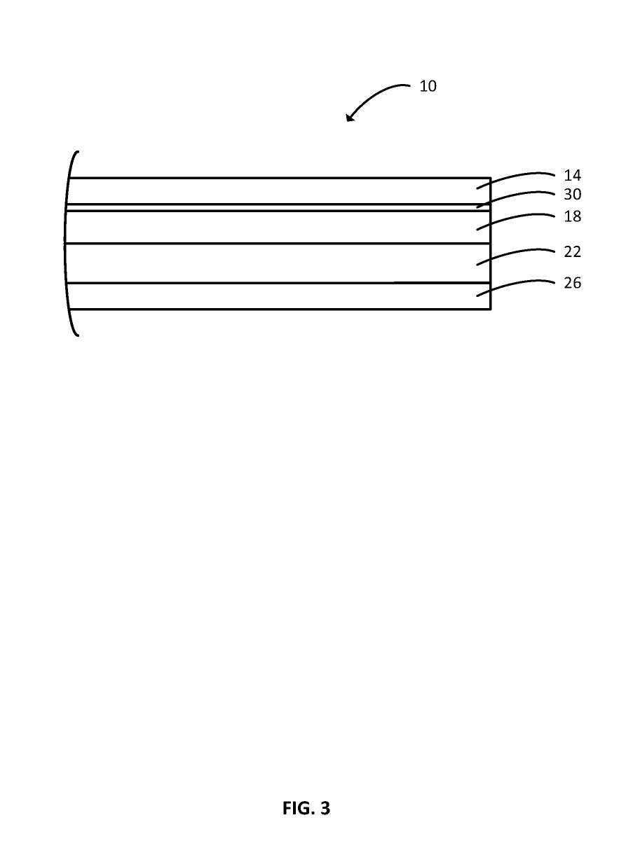

Referring now to FIGS. 2 and 3, the protective covering material 10 may be constructed in such a manner that the first layer 14 includes a durable scratch and temperature resistant clear coat and a UV inhibiting compound is formed as a separate layer 30. The UV inhibiting layer 30 may be formed on top of the first layer 14 as illustrated in FIG. 2 or on bottom of the first layer 14, between the first layer 14 and the second layer 18, as illustrated in FIG. 3. In one example, the outer layer 14 is formed with a scratch and wear resistant clear coat and the UV inhibiting layer 30 is formed beneath the outer layer 14; between the outer layer 14 and the core layer 18. In one example, the UV inhibiting layer 30 may be formed from a urethane acrylate polymer with a nano silica coating applied on the urethane acrylate polymer. The nano silica coating may be about 0.003 or 0.004 inches thick.

In this manner, the UV inhibiting layer may provide effective UV protection to the countertop material which is protected by the covering material 10 and may also provide UV protection to the layers of the protective covering material 10 disposed between the UV protection layer 30 and the countertop to which the covering material 10 is applied.

The protective covering material 10 may be designed for application to various different countertop materials. As such, the protective covering material may be provided in varying thicknesses. According to one embodiment, the protective covering material 10 may be provided in varying thicknesses between 0.002 inches thick and 0.020 inches thick. According to another embodiment, the protective covering material 10 may be provided in varying thicknesses between 0.005 inches thick and 0.010 inches thick. These different thicknesses may each provide similar protection properties. As such, the varying thicknesses may each provide UV protection, chemical protection, impact resistance, and scratch resistance.

The protective covering material 10 is typically provided in uniform thin sheets having sufficient width and length to cover a desired countertop or surface. In one embodiment, the protective covering material 10 may be provided with a glossy clear or matte clear surface finish and may thus complement various different countertop materials.

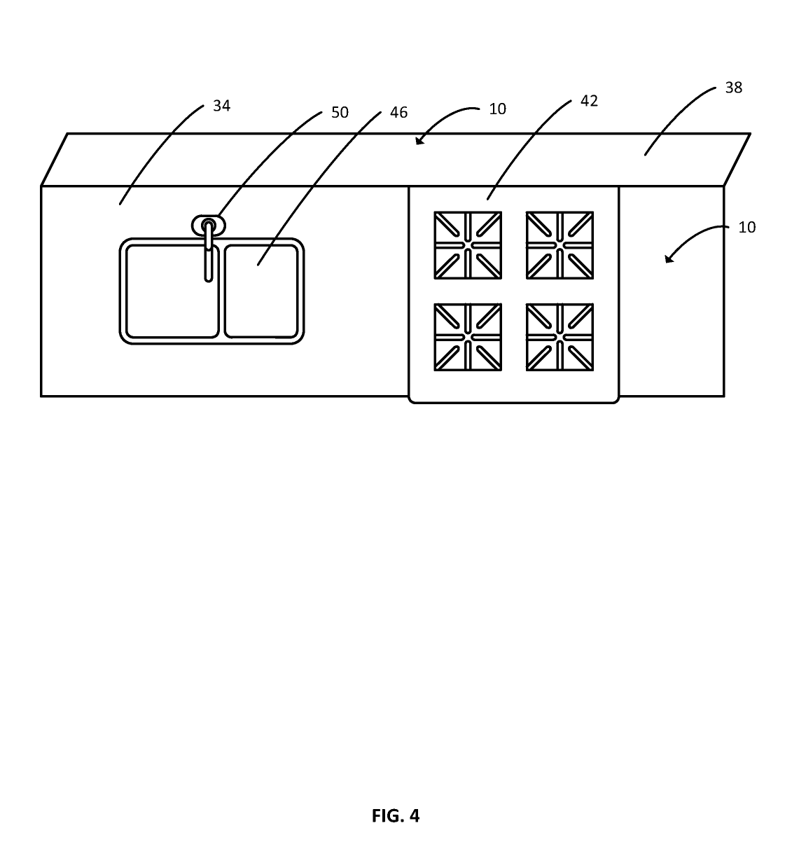

Referring now to FIG. 4, a countertop 34 is shown with the protective covering material 10 attached thereto. The countertop 34 may include a backsplash 38. The exemplary countertop 34 is a kitchen countertop, and as such may have a stove 42, a sink 46, or another such item installed therewith. As has been discussed, the application of the protective covering material 10 to the countertop 34 is exemplary of the other locations within a residential or commercial location where solid surface countertop materials may be used. Thus, the principles discussed herein refer to showers, bars, etc.

The protective covering material 10 may frequently be installed on the countertop 34 by using a liquid and a squeegee. In such an installation, a piece of protective covering material may be cut to a desired size, typically a size slightly larger than the countertop 34. The countertop 34 may be thoroughly cleaned and a small amount of a liquid may be applied to the countertop 34. The release layer 26 may be removed from the protective covering material 10 and the protective covering material 10 may then be placed on the countertop. A squeegee may be used to press the protective covering material against the countertop 34, simultaneously removing bubbles and excess liquid. It will be appreciated that, in some applications, items such as faucets 50, stoves 42, etc. may be removed from the countertop 34 for installation of the protective covering material 10 or the protective covering material 10 may be installed before these items are installed on the countertop 34.

In some places, the protective covering material 10 may be cut and trimmed. By way of example, the protective covering material 10 may be trimmed around a stove 42, sink 46, faucet 50, etc. The protective covering material 10 may be adhered to the surface of the countertop 34. By way of example, the protective covering material 10 may be used to cover the edge of the countertop 34, etc.

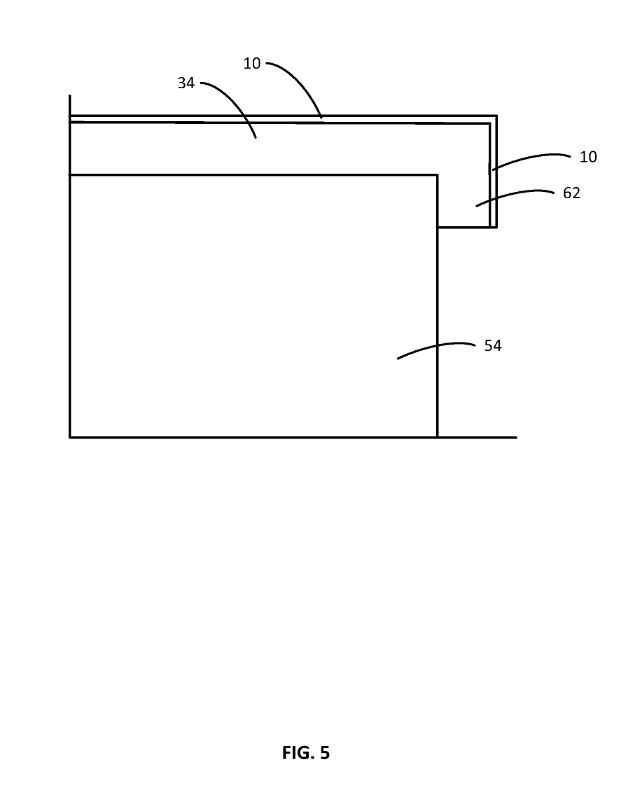

Referring now to FIG. 5, a side view of a portion of the countertop 34 is shown. The countertop 34 is shown from inside of an opening formed for the stove 42. As such, the countertop 34 terminates at a cut edge adjacent a cabinet 54. As can be seen, the front of the countertop 34 is formed with an extended drip edge 62. The covering material 10 may be adhered to the drip edge 62. The covering material is cut along the opening for the stove 42 and the stove 42 may be placed in the opening after the protective covering material is installed.

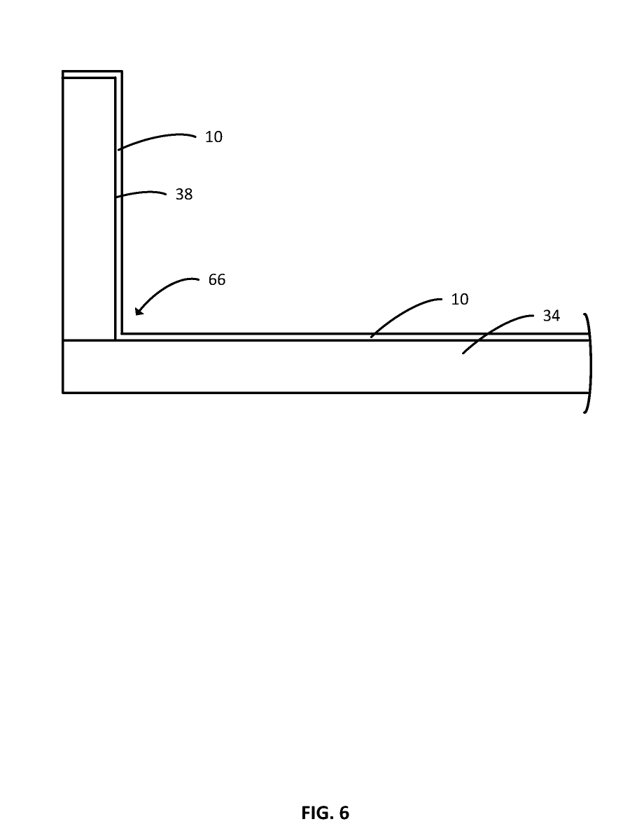

Referring now to FIG. 6, a side view of a portion of a countertop 34 and a backsplash 38 is shown. The protective covering material 10 has been applied to the countertop 34 and to the backsplash 38. In some situations, the protective covering material 10 must be attached at a corner as indicated at 66. The covering material 10 may be cut as needed for installation to the corner 66 and the countertop 34.

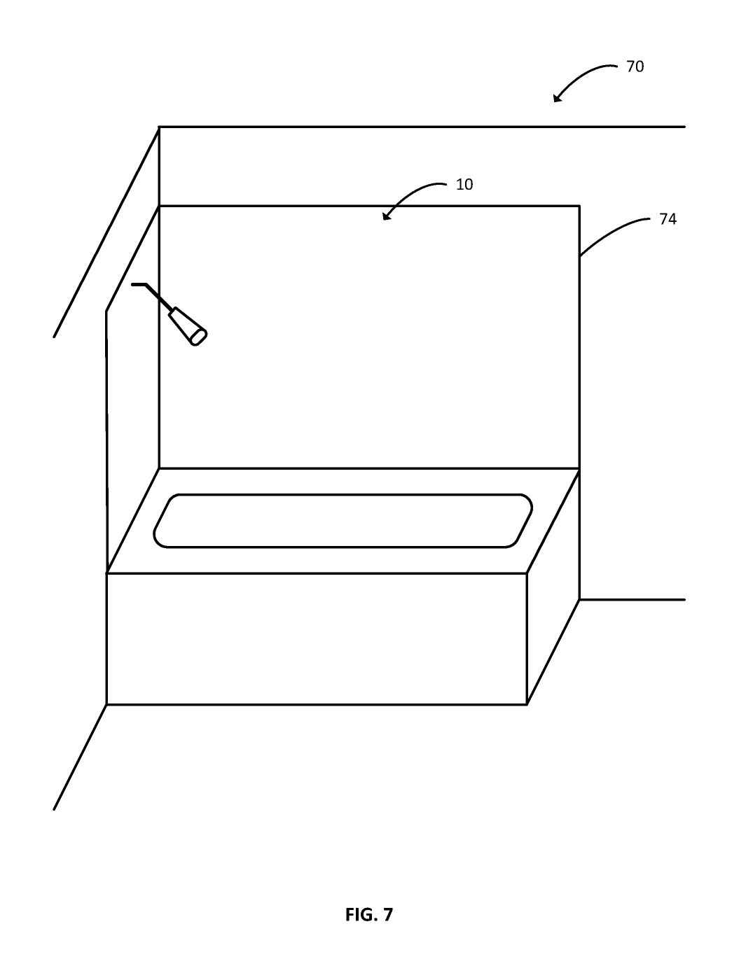

Referring now to FIG. 7, a side view of a shower, generally indicated at 70 is shown. The protective covering material 10 has been applied to the shower 70 to protect the shower. More particularly, the protective covering material 10 has been applied to the countertop material which has been used to make the shower surround 74. The shower surround may often be made with a countertop material such as a synthetic marble. Synthetic marble is often made of a decorative element such as ground stone in a binder such as a resin.

In one embodiment, the protective covering material 10 provides a clear protective film covering for solid surface countertops. More particularly, the protective film covering attaches to the countertop surface through an optically clear pressure-sensitive adhesive layer 22 which may be an acrylic adhesive or a silicone adhesive system on the bottom side of the protective film. The adhesive system is designed to accommodate the porous nature of certain material such as stone. In some cases, the adhesive layer 22 may conform to the countertop material such that minor variations in the surface of the countertop material are accommodated by the adhesive. Air pockets or locations where the adhesive does not contact the countertop material may be eliminated, improving the appearance of the countertop material.

The protective covering material 10 may provide a satin or a high gloss surface that will typically enhance the appearance of a high grade countertop material such as stone, stainless steel, or glass. The protective covering material 10 is typically transparent and retains the appearance and appeal of a countertop material such as stone or recycled glass. The protective covering material 10 strengthens these countertop materials as it provides greater resistance to chipping, breaking, temperature, staining, etching, and UV degradation.

In one example, a protective film covering is provided to protect the surface of solid surface countertop materials in both commercial and residential areas such as kitchen countertops, bathroom sinks, showers, and bathroom walls from damage such as chipping, scratching, chemical and hard water etching, UV degradation, etc. The protective film covering may be formed with an integrated clear coat layer 14 that is chemically resistant to common liquids such as citrus juices, coffee, tomato juice, wine, and other acidic liquids. These liquids are frequent sources of etched or stained countertops and backsplashes. This chemical resistant clear coat layer 14 has a high heat resistance and can handle contact with temperatures up to 300 degrees Fahrenheit. The heat resistant clear coat layer 14 provides protection against hot pots and pans commonly found in the kitchen. The clear coat layer 14 also provides protection against spills of hot liquids. In many situations, the protective covering material 10 allows hot pots and pans to be placed on the countertop without causing damage.

In one example, the protective covering material 10 is permanently installed onto a countertop material. The protective covering material 10 adheres to the surface of the countertop material by virtue of the adhesive layer 22. The selected adhesives used in the adhesive layer 22 provide a durable bond between the protective covering material 10 and the countertop material which prevents delamination and maintains protection of the countertop material. Permanent installation does not signify that the protective covering material 10 may not be repaired if necessary. With sufficient effort, the protective covering material 10 may be removed from the countertop material and the countertop material may be properly cleaned and prepared to receive a replacement piece of protective covering material 10. Such replacement of the protective covering material 10 may occur when the protective covering material 10 is damaged such as where a person accidentally cuts the protective covering material 10 while working with a knife.

Permanent installation, however, means that the protective covering material 10 is strongly bonded to the countertop material such that it is not easily removed from the countertop material. The protective covering material 10 is not temporarily attached to the countertop material during installation similar to static cling plastic as is often used to protect electronic screens or appliances which these devices are removed from their packaging and installed. With these devices, the temporary static films are removed prior to use of the device. In contrast, the protective covering material 10 is permanently installed prior to use of the countertop. The protective covering material 10 remains properly attached to the countertop material while the countertop is used.

Once installed, the protective covering material 10 requires minimal maintenance and retains the natural look of the countertop material. As the clarity of the protective covering material 10 is of high importance, each component of this film is designed for maximum clarity. In this manner, the protective covering material 10 is aesthetically pleasing when it is installed onto the countertop material. Materials such as stone or glass retain their appearance and in some cases are visually improved by the consistency of the surface provided by the protective covering material 10. The physical, chemical, and heat resistance of the protective covering material 10 will protect the countertop material and preserve the beauty of the countertop material. The UV inhibiting component of the protective covering material 10 will reduce or eliminate fading and damage due to UV exposure and countertop materials located where they are exposed to sunlight will exhibit minimal color fading over time.

The protective covering material typically eliminates the need for using coasters, place mats, and the like. The protective covering material eliminates the frequent application of stone sealers and other chemical treatments. This reduces the amount of chemicals used and reduces the work necessary for preserving the countertop material. The protective covering material 10 provides surface and edge protection to a countertop material without obstructing the beauty of the countertop.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific materials, thicknesses, etc., are provided for explanation purposes and that other structures may also be employed in other embodiments and examples in accordance with the teachings of the present invention.

What is claimed is:

1. A protective covering material for solid surface countertop materials comprising:
a core layer formed from a polymer material, the core layer defining an elongate thin sheet having uniform thickness;
an outer protective clear coat layer attached to a first side of the core layer; and
an adhesive layer attached to a second side of the core layer.

2. The protective covering material of claim 1, wherein the outer layer is formed from polymerized acrylate.

3. The protective covering material of claim 1, wherein the core layer is formed from polyethylene terephthalate.

4. The protective covering material of claim 1, wherein the protective covering material is between about 0.005 and about 0.01 inches thick.

5. The protective covering material of claim 1, further comprising a UV inhibiting layer disposed between the outer protective clear coat layer and the core layer.

6. The protective covering material of claim 5, wherein the UV inhibiting layer comprises a silica coating.

7. The protective covering material of claim 1, further comprising an antibacterial agent formed as part of the outer protective clear coat layer.

8. The protective covering material of claim 1, wherein the protective covering material is optically clear.

9. A system comprising the protective covering material of claim 1, and further comprising:
a solid surface countertop material; and
wherein the protective covering material is permanently adhered to the solid surface countertop material with the adhesive layer.

10. The system of claim 9, wherein the solid surface countertop material is an item selected from the group consisting of: a counter, a backsplash, a bar, a shower, and a vanity.

11. The system of claim 9, wherein the solid surface countertop material is selected from the group consisting of: stone, Caesarstone, glass, metal, and composite materials containing decorative elements in a binder.

12. A method for protecting a solid surface countertop material comprising:
selecting a solid surface countertop material;
selecting a protective covering material, the protective covering material comprising:
a core layer formed from a polymer material, the core layer defining an elongate thin sheet having uniform thickness;
an outer protective clear coat layer attached to a first side of the core layer; and
an adhesive layer attached to a second side of the core layer; and
permanently adhering the protective covering material to the solid surface countertop material with the adhesive layer.

13. The method of claim 12, wherein the solid surface countertop material is an item selected from the group consisting of: a counter, a backsplash, a bar, a shower, and a vanity.

14. The method of claim 12, wherein the solid surface countertop material is selected from the group consisting of: stone, Caesarstone, glass, metal, and composite materials containing decorative elements in a binder.

15. The method of claim 12, wherein the core layer is formed from a polyolefin.

16. The method of claim 15, wherein the core layer is formed from polyethylene.

17. The method of claim 12, wherein the protective covering material is between about 0.005 and about 0.01 inches thick.

18. The method of claim 12, wherein the outer protective clear coat layer further comprises a UV inhibiting material.

19. The method of claim 12, wherein the protective covering material further comprises a UV inhibiting layer disposed between the outer protective clear coat layer and the core layer.

20. The method of claim 12, wherein the protective covering material is optically clear.
